(19) United States
(12) Patent Application Publication
(10) Pub. No.: US 2004/0079042 A1
(43) Pub. Date: Apr. 29, 2004

(54) Multi-layer laminated shingle

(76) Inventor: Bert W. Elliott, Westerville, OH (US)

Correspondence Address: OWENS CORNING, 2790 COLUMBUS ROAD, GRANVILLE, OH, 43023, US

(21) Appl. No.: 10/282,997

(22) Filed: Oct. 29, 2002

(51) Int. Cl. E04D 1/28; B32B 31/00

(52) U.S. Cl. 52/557; 52/554; 428/144; 156/260; 52/559

(57) ABSTRACT

A laminated shingle has a horizontal longitudinal orientation, and includes a first overlay sheet having a series of horizontally extending tabs and cutouts. Each tab has a front edge. An underlay sheet includes more than one section, and each section has a vertical length relative to a back edge of the underlay sheet. The vertical lengths of at least some of the sections differ from each other, and each section has a front edge and is associated with one or more tabs of the overlay sheet. The underlay sheet is laminated beneath the first overlay sheet. The front edge of each section of the underlay sheet is substantially aligned vertically with the front edge of its associated one or more tabs of the overlay sheet.

### TECHNICAL FIELD AND INDUSTRIAL APPLICABILITY OF THE INVENTION

This invention relates to laminated shingles, and in particular to multi-layered laminated shingles having a cutout and tab configuration which provides a three-dimensional effect with richness and depth.

### BACKGROUND OF THE INVENTION

In the past, roofing shingles have had to satisfy two main functions when applied to a roof deck. The first function is to provide a durable, weatherproof covering for the roof deck. Roof shingles, whatever their form, are intended to provide a means of sheltering the structure below the shingles from precipitation and the deleterious effects of sun and wind. Roof shingles installed on the roof deck must perform these protecting functions for a reasonable period of time. The second function is to present an aesthetically pleasing architectural feature which enhances the overall appeal of the structure to which the shingles have been applied. This aesthetic function has been satisfied by providing asphalt shingles with various butt edge contours and surface treatments which operate to simulate more traditional, and in most cases more expensive, forms of roof coverings, such as thatch, wooden shakes, slates, and even tiles of various forms.

It would be advantageous if there could be developed a laminated shingle having an improved aesthetically pleasing appearance when the shingle is applied with other similar shingles as a roof covering on a roof.

### SUMMARY OF THE INVENTION

The invention relates to a laminated roofing shingle including an overlay with cutouts and tabs, and an underlay with tabs such that the shingle provides a three-dimensional effect with richness and depth. The laminated shingle has a horizontal longitudinal orientation and includes a first overlay sheet having a front edge. An underlay sheet includes a front edge, and is laminated beneath the first overlay sheet. The front edge of the overlay sheet is substantially aligned with the front edge of the underlay sheet. Preferably, the overlay sheet includes a series of tabs and cutouts extending horizontally across the shingle. The first overlay sheet has a first end and a second end. Preferably, a first cutout defines the first end of the first overlay sheet, and a second cutout defines the second end of the first overlay sheet. The underlay sheet preferably includes more than one section, and the sections have more than one length relative to a back edge of the underlay sheet.

According to this invention there is also provided a method of making shingles. Initially, a continuously supplied shingle mat is coated with roofing asphalt to make an asphalt coated sheet. The asphalt coated sheet is covered with granules to form a continuous granule covered sheet, wherein the continuous granule covered sheet comprises a first overlay sheet, a second overlay sheet, and an underlay sheet. The second overlay sheet is then longitudinally cut from the continuous granule covered sheet. The second overlay sheet is then laminated to an underside of the first overlay sheet of the continuous granule covered sheet, wherein the first overlay sheet and the second overlay sheet define an overlay assembly portion. Simultaneously, a pattern of tabs and cutouts are then cut in the overlay assembly portion, and a pattern of sections are cut in the underlay sheet of the continuous granule covered sheet. The underlay sheet is thereby separated from the overlay assembly portion and defines a continuous underlay sheet, and the overlay assembly portion defines a continuous overlay assembly. The pattern of underlay sections of the continuous underlay sheet are then synchronized relative to the pattern of tabs and cutouts of the continuous overlay assembly. The continuous underlay sheet is then laminated to an underside of the continuous overlay assembly to form a continuous laminated shingle sheet. The pattern of tabs and cutouts of the continuous laminated shingle sheet are then synchronized relative to a shingle length cutter. The continuous laminated shingle sheet is then cut with the shingle length cutter such that each cut is in made through a cutout of the continuous laminated shingle sheet.

Various objects and advantages of this invention will become apparent to those skilled in the art from the following detailed description of the preferred embodiments, when read in light of the accompanying drawings.

### BRIEF DESCRIPTION OF THE DRAWINGS

FIG. 1 is a schematic elevational view of a shingle manufacturing operation capable of making the laminated shingles according to the invention.

FIG. 2 is a schematic plan view of the granule covered sheet taken along line 2-2 of FIG. 1, illustrating the first overlay, second overlay, and underlay sheets of the granule covered sheet.

FIG. 3 is a schematic plan view of the overlay assembly illustrated in FIG. 2, showing the tab and cutout pattern according to the invention.

FIG. 4 is a schematic plan view of a laminated shingle according to the invention, showing slits in a tab of the first overlay sheet.

FIG. 5 is an exploded schematic perspective view of a laminated shingle according to the invention.

FIG. 6 is a partial plan view of a roof having a roof covering of laminated shingles according to the invention.

FIG. 7 is a partial plan view of a roof having a roof covering of an alternate embodiment of laminated shingles according to the invention, showing a shadow line.

FIG. 8 is a partial plan view of a roof having a roof covering of another alternate embodiment of laminated shingles according to the invention, showing a shadow line.

FIG. 9 is a schematic perspective view of the laminated shingle illustrated in FIG. 5.

### DETAILED DESCRIPTION AND PREFERRED EMBODIMENTS OF THE INVENTION

Composite shingles, such as asphalt shingles, are a commonly used roofing product. Asphalt shingle production generally includes feeding a base material from a roll fed downstream and coating it first with a composite material, then a layer of granules. The base material is typically made from a fiberglass mat provided in a continuous shingle membrane or sheet. It should be understood that the base material can be any suitable support material.

The composite material, such as an asphalt material, is added to the continuous shingle membrane for strength and improved weathering characteristics. It should be understood that the composite material can be any suitable material, preferably low in cost, durable, and resistant to fire. The layer of granules is typically applied with one or more granule applicators, such as pneumatic blenders, to the asphalt material covering the continuous shingle membrane. The pneumatic blender is a type of granule applicator known in the art. The granules shield the asphalt material from direct sunlight, offer resistance to fire, and provide texture to the shingle. The granules can be colored in a way known in the art, preferably before being applied to the continuous shingle membrane. The granules are preferably applied to the continuous shingle membrane in color patterns to provide the shingles with an aesthetically pleasing appearance. Preferably, shingles manufactured according to the invention will present an aesthetically pleasing architectural appearance which enhances the overall appeal of the structure to which the shingles have been applied. More preferably, the shingles will simulate a traditional, cedar shake shingle.

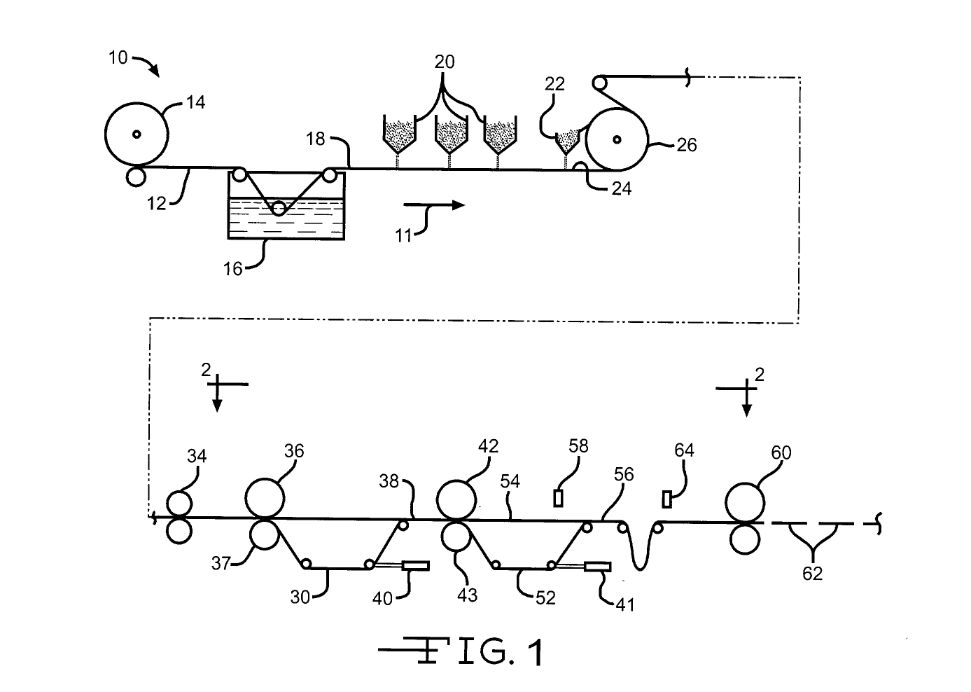

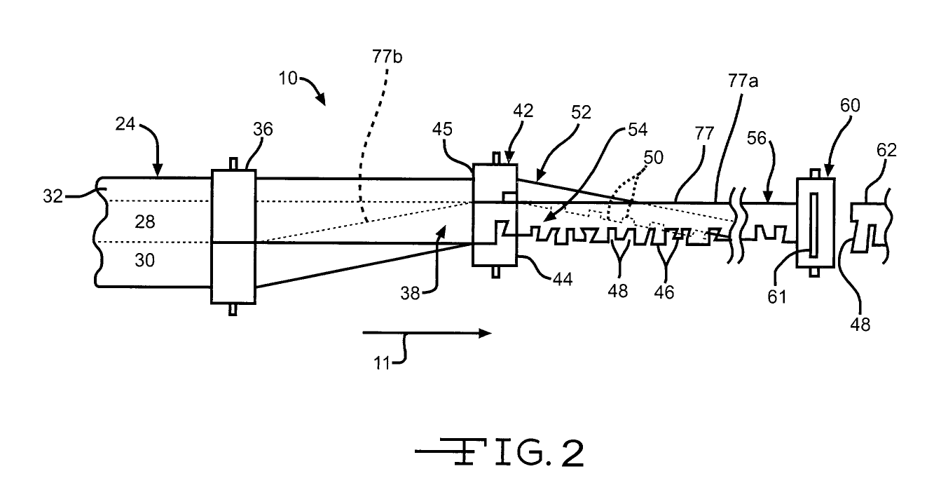

Referring now to the drawings, there is shown in FIGS. 1 and 2 an apparatus 10 for manufacturing an asphalt-based roofing material according to the invention. The illustrated manufacturing process involves passing a continuous shingle mat 12 in a machine direction, indicated by the arrow 11, through a series of manufacturing operations. The mat 12 usually moves at a speed of at least about 200 feet/minute (61 meters/minute), and typically at a speed within the range of between about 450 feet/minute (137 meters/minute) and about 800 feet/minute (244 meters/minute).

In a first step of the manufacturing process, a continuous sheet of substrate or shingle mat 12 is payed out from a roll 14. The substrate can be any type suitable for use in reinforcing asphalt-based roofing materials, such as a nonwoven web of glass fibers. The shingle mat 12 is fed through a coater 16 where asphalt coating is applied to the sheet. The asphalt coating can be applied in any suitable manner. In the illustrated embodiment, the sheet is submerged in a supply of hot, melted asphalt coating to completely cover the sheet with the tacky coating. However, in other embodiments, the asphalt coating could be sprayed on, rolled on, or applied to the sheet by other means. Typically the asphalt material is highly filled with a ground stone filler material, amounting to at least about 60 percent by weight of the asphalt/filler combination.

The resulting asphalt coated sheet 18 is then passed beneath a series of granule or blend drop dispensers 20 for the application of granules to the upper surface of the asphalt coated sheet. The granule dispensers can be of any type suitable for depositing granules onto the asphalt coated sheet. A preferred granule dispenser is a granule blender of the type disclosed in U.S. Pat. No. 5,599,581 to Burton et al., which is hereby incorporated by reference, in its entirety. The blend drop dispensers 20 are designed to discharge blend drops of granules onto the asphalt coated sheet 18. Different ones of the series of blend drop dispensers 20 can be arranged to apply blend drops of different shapes and color blends. Such a use of multiple blend drop dispensers is well known in the art.

As is well known in the art, blend drops applied to the asphalt coated sheet are often made up of granules of several different colors. For example, a particular blend drop that is intended to simulate a weathered wood appearance can consist of some brown granules, some dark gray granules and some light gray granules. When these granules are mixed together and applied to the sheet in a generally uniformly mixed manner, the overall appearance of weathered wood is achieved. For this reason, the blend drops are referred to as having a color blend, which gives an overall color appearance, and this overall appearance may be different from any of the actual colors of the granules in the color blend. Also, blend drops of darker and lighter shades of the same color, such as, for example, dark gray and light gray, are referred to as different color blends rather than merely different shades of one color.

Subsequent to the application of the blend drops by the blend drop dispensers 20, background and backfall granules are deposited by a backfall hopper 22 onto the asphalt coated sheet 18. The background and backfall granules adhere to the portions of the asphalt coated sheet 18 that not are already covered by the blend drop granules. The background and backfall granules are applied to the extent that the asphalt coated sheet 18 becomes completely covered with granules, and the sheet becomes a granule covered sheet 24. The granule covered sheet 24 is then inverted by traveling around a slate drum 26, which causes any excess granules to drop off on the backside of the drum 26 and consequently be removed from the granule covered sheet 24. The excess granules are intercepted by the backfall hopper 22, which is positioned on the backside of the slate drum 26. As best shown in FIG. 2, the granule covered sheet 24 includes a first overlay sheet 28, a second overlay sheet 30, and an underlay sheet 32.

After passing around the slate drum 26, the granule covered sheet 24 is cooled, and subsequently cut into continuous strips, as described herein. The continuous granule covered sheet 24 is preferably fed through pull rollers 34 that regulate the speed of the granule covered sheet 24 as it moves downstream. In a preferred embodiment, at least one of the pull rollers 34 is driven by a motor (not shown). The granule covered sheet 24 then fed through a first cutting cylinder 36 and first backup roller 37. As shown in FIG. 2, the first cutting cylinder 36 longitudinally cuts the granule covered sheet 24, thereby dividing the second overlay sheet 30 from the remainder of the granule covered sheet 24, and defining a substantially straight back edge 77b of the second overlay sheet 30.

The second overlay sheet 30 is then continuously fed beneath the first overlay sheet 28 of the granule covered sheet 24. A laminating adhesive is applied to adhere the second overlay sheet 30 and the first overlay sheet 28 together. The laminated first and second overlay sheets 28 and 30 define an overlay assembly portion 38 of the granule covered sheet 24. Preferably various alignment and synchronization mechanisms, such as a hydraulic path length adjuster 40, are used to assure that the desired alignment between the second overlay sheet 30 and the first overlay sheet 28 is achieved.

The continuous granule covered sheet 24 is then fed through a second cutting cylinder 42 and second backup roller 43. As shown in FIG. 2, the second cutting cylinder 42 is a pattern cutter having first and second cutting portions 44 and 45, respectively. The first cutting portion 44 preferably has a dragon tooth design for cutting a pattern of tabs 46 and cutouts 48 in the overlay assembly portion 38. It is understood that the terrn “cutout” is defined as the space between two adjacent tabs 46. The second cutting portion 45 has a design for cutting a pattern of underlay sections 50 in the underlay sheet 32. The pattern of tabs 46 and cutouts 48 of the overlay assembly portion 38, and the pattern of sections 50 of the underlay sheet 32, will be described in detail herein. The second cutting portion 45 also longitudinally cuts the continuous granule covered sheet 24, separating the underlay sheet 32 from the overlay assembly portion 38, and defining a substantially straight back edge 77a of the first overlay sheet 28. The back edge 77a and the back edge 77b define a substantially straight back edge 77 of the overlay assembly portion 38. The separated underlay sheet 32 thereby defines a continuous underlay sheet 52, and the separated overlay assembly portion 38 defines a continuous overlay assembly 54.

The continuous underlay sheet 52 is continuously fed beneath the overlay assembly 54. A laminating adhesive is applied to adhere the continuous underlay sheet 52 to the overlay assembly 54 to form a continuous laminated shingle sheet 56. Preferably, various alignment and synchronization mechanisms, such as a second hydraulic path length adjuster 41, are used to assure that the desired alignment between the continuous underlay sheet 52 and the overlay assembly 54 is achieved. It will be understood that the first hydraulic path length adjuster 40 can be the same as the second hydraulic path length adjuster 41, or the first and second hydraulic path length adjusters 40 and 41 can be different. Additionally, a first sensor 58, can be used to synchronize the pattern of underlay sections 50 of the continuous underlay sheet 52 relative to the pattern of tabs 46 and cutouts 48 of the overlay assembly 54. Preferably, the first sensor 58 is an optical device which can sense the pattern of tabs and cutouts on the laminated shingle sheet 56. A controller (not shown) can also be provided for controlling the path length adjuster 41. Any other desired method of aligning the pattern of underlay sections 50 relative to the pattern of tabs 46 and cutouts 48 of the overlay assembly 54 can also be employed.

The continuous laminated shingle sheet 56 is then fed through a shingle length cutter 60, which engages and divides the continuous laminated shingle sheet 56 into discrete roofing shingles 62. Preferably, the length cutter 60 includes a blade 61. The length cutter 60 can also be of any type suitable for cutting the laminated shingle sheet 56 into discrete shingles. The blade 61 preferably cuts the laminated shingle sheet 56 through a cutout 48, as shown in FIG. 2. Preferably, an alignment and synchronization mechanism, such as a second sensor 64, is provided. Preferably, the second sensor 64 is an optical device which can sense the pattern of tabs 46 and cutouts 48 on the laminated shingle sheet 56, and is used to synchronize the pattern of tabs 46 and cutouts 48 of the continuous laminated shingle sheet 56 relative to the length cutter 60. The first and second sensors 58 and 64 can also be used to sense timing marks (not shown) placed on the first overlay sheet 28 at intervals corresponding with each cutout 48. A controller (not shown) can also be provided for controlling the rotational speed of the end cutter 60. Any other method of aligning the pattern of tabs 46 and cutouts 48 relative to the length cutter 60 can also be employed. After the continuous laminated shingle sheet 56 is cut into discrete shingles 62, the shingles 62 are packaged in bundles (not shown) for transportation to customers.

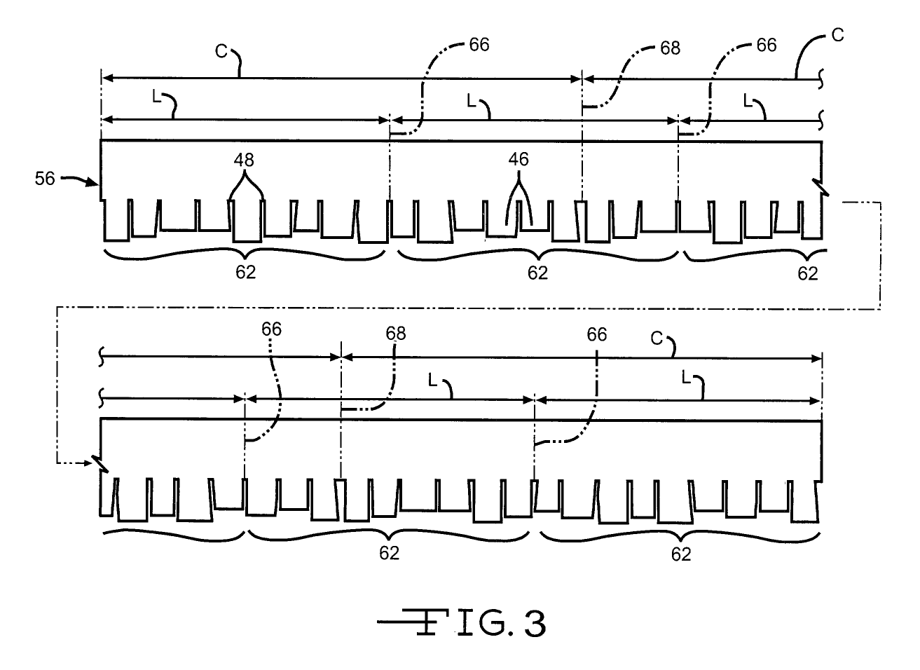

Preferably, a circumference of the second cutting cylinder 42 and a horizontal length L of the shingle 62 have a specifically defined relationship. As best shown in FIG. 3, the horizontal length L of the shingle is ⅗ of the circumference of the second cutting cylinder 42. For example, a commonly produced shingle length is 39 inches. In such a case, the preferable circumference of the second cutting cylinder 42 is 65 inches. U.S. Pat. No. 5,102,487 to Lamb describes such relationship between a circumference of the cutting cylinder and a horizontal length of the shingle, and is incorporated herein by reference. For purposes of clarity, FIG. 3 illustrates the shingle sheet 56 with the underlay sheet 52 removed.

FIG. 3 illustrates one embodiment of the continuous laminated shingle sheet 56. Specifically, FIG. 3 illustrates a portion of the continuous laminated shingle sheet 56 showing the pattern of tabs 46 and cutouts 48 which would be produced by three revolutions of the second cutting cylinder 42. This pattern would be repeated indefinitely every three revolutions of the second cutting cylinder 42. Phantom lines 66 indicate where the shingle sheet 56 would be cut into the discrete roofing shingles 62, each shingle having a horizontal length L. Phantom lines 68 indicate where a pattern, having a length C equal to the circumference of the second cutting cylinder 42, begins and ends. As illustrated in FIG. 3, each of the five shingles 62 produced has a different tab and cutout pattern.

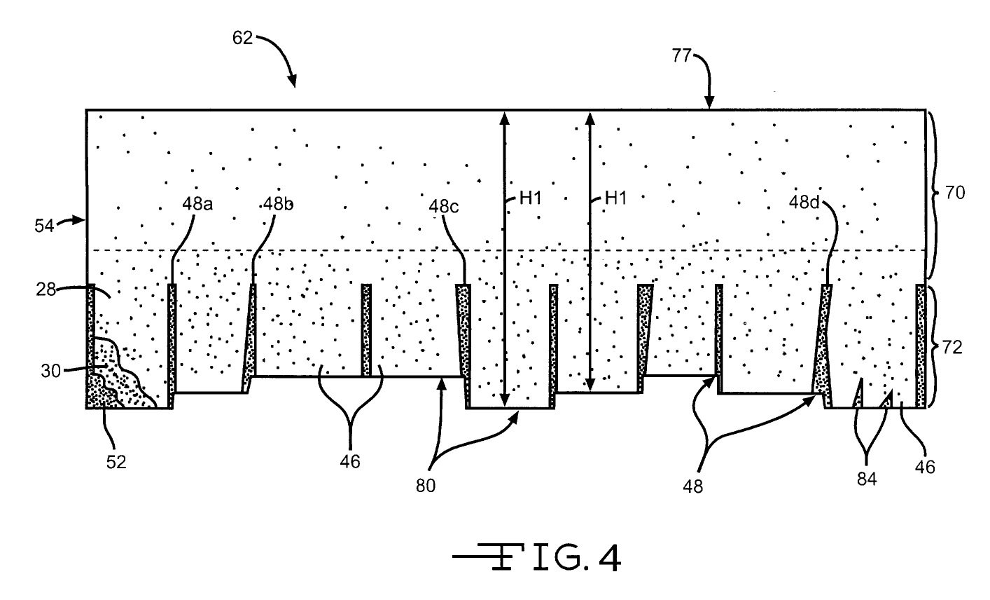

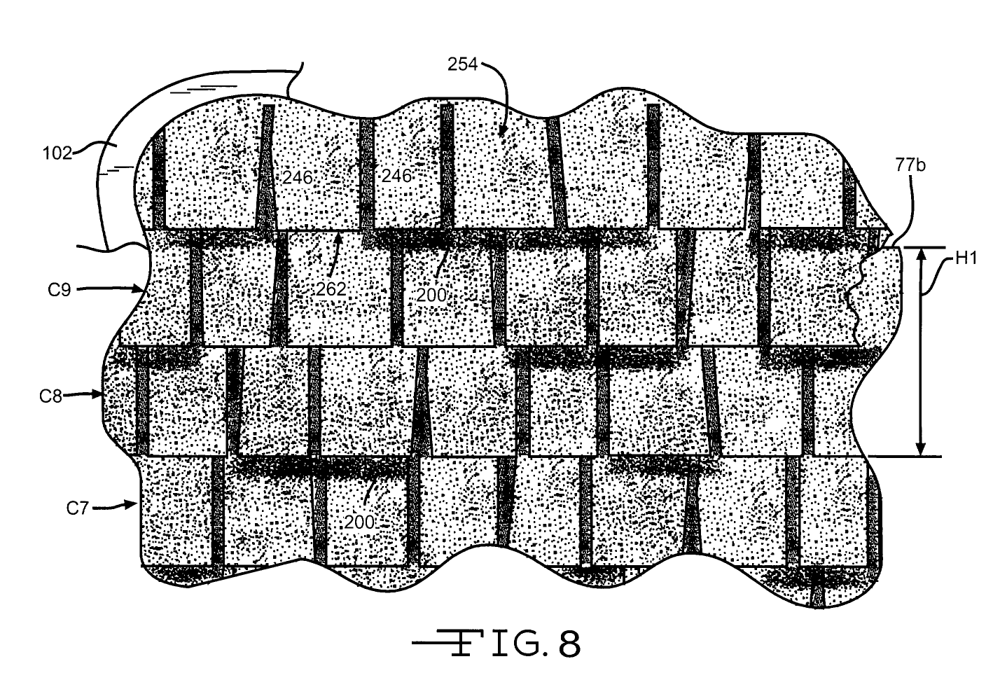

As shown in FIG. 4, the laminated shingle 62 has an overall horizontal longitudinal orientation, and is comprised of the overlay assembly 54, and the underlay sheet 52. The overlay assembly 54 is preferably comprised of identically formed first and second overlay sheets 28 and 30, respectively, laminated together. It will be understood that the overlay assembly 54 can also be formed of any desired number of overlay sheets, such as three or four overlay sheets. Additionally, the overlay sheets could be laminated first, and the tabs and cutouts formed after lamination of the sheets. The overlay assembly 54 includes an upper or headlap area 70 and a lower, butt or tab area 72. The tab area 72 includes a series of the tabs 46 and the cutouts 48, extending horizontally across the shingle 62. Preferably, each shingle 62 includes a plurality of tabs 46 having differing vertical tab lengths H1, as shown in FIGS. 4, 5, and 9. However, the tabs 46 can have any desired vertical tab length H1, or combination of different vertical tab lengths H1. Additionally, the tabs 46 can be of equal vertical length, as shown in FIG. 8. In reference to each tab 46, vertical length is defined as a length in a vertical direction from the back edge 77 to a front edge 80 of each tab 46. It will be understood that if the front edge 80 of a tab 46 is not substantially horizontal, wherein substantially horizontal is defined as substantially parallel with the back edge 77a and 77b, the vertical length H1 will be an average the vertical length of the tab 46.

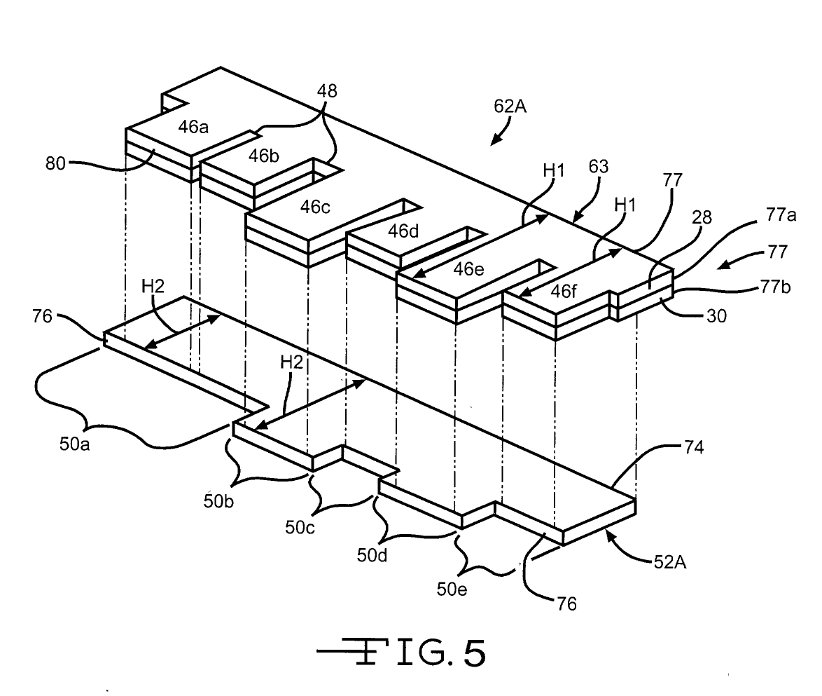

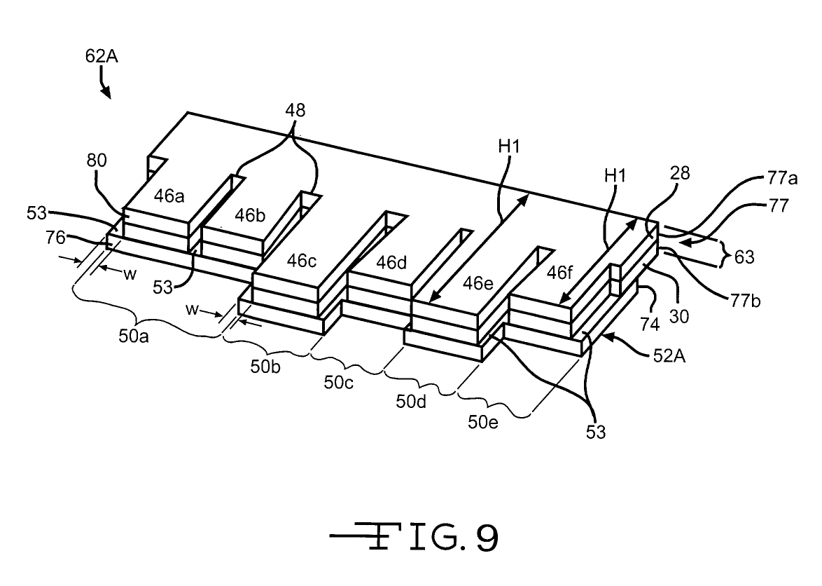

FIGS. 5 and 9 schematically illustrate an alternate embodiment of the shingle 62A. The shingle 62A includes an overlay assembly 63 having six tabs 46a, 46b, 46c, 46d, 46e, and 46f, although six tabs are not required. The overlay assembly 63 can also be formed having any desired number of tabs. As shown in FIGS. 5 and 9, the second overlay sheet 30 can extend to the full vertical length H1 of the first overlay sheet 28, such that the back edge 77a and the back edge 77b are substantially aligned vertically. As used herein, aligned vertically is defined as aligning the back edge 77a of the first overlay sheet 28 with the back edge 77b of the second overlay sheet 30, such that there is substantially no separation between the back edge 77a and the back edge 77b in the vertical direction. Alternately, the second overlay sheet 30 can also be shortened (not shown) so that it merely extends vertically enough to fully underlie the cutouts 48 of the first overlay sheet 28. In such an overlay assembly, the back edge 77b is not substantially aligned vertically with the back edge 77a.

As best shown in FIG. 5, the underlay sheet 52A has more than one vertical length H2. As used herein, the vertical length of the underlay sheet 52A is defined as a length in a vertical direction from a back edge 74 to a front edge 76 each underlay section 50. Each underlay sheet 52A can have more than one vertical length H2. Each portion of the underlay sheet 52A having a different vertical length H2 defines an underlay section 50. For example, FIGS. 5 and 9 illustrate the underlay sheet 56A having five sections 50a, 50b, 50c, 50d, and 50e, although the underlay can have any desired number of sections 50.

As best shown in FIGS. 5 and 9, each section 50a through 50e is associated with one or more tabs 46a through 46f of the overlay assembly 63. Preferably, no more than two adjacent tabs, such as the tabs 46a and the tab 46b of the overlay assembly 63 have substantially equal vertical lengths H1. The front edge 80 of each overlay assembly tab 46a through 46f is preferably substantially aligned vertically with the front edge 76 of an associated underlay section 50a through 50e. As used herein, aligned vertically is defined as aligning the front edge 80 of each tab 46a through 46f with the front edge 76 of the underlay section 50a through 50e to which each tab 46a through 46f is laminated, such that there is substantially no separation between the tab front edge 80 and the underlay section front edge 76 in the vertical direction.

As best shown in FIG. 4, the cutouts 48 can be formed having a variety of shapes. An embodiment of a cutout includes cutout edges that are substantially parallel to each other, as illustrated by the cutout 48a. An alternate embodiment of a cutout includes cutout edges that are tapered so that they are horizontally wider toward a front edge 82 of the shingle 62, as illustrated by the cutout 48b. Another embodiment of a cutout includes cutout edges that are tapered so that they are horizontally narrower toward the front edge 82 of the shingle 62, as illustrated by the cutout 48c. Another embodiment of a cutout includes a rear cutout portion having cutout edges that are substantially parallel to each other, and a tapered front cutout portion such that the front cutout portion is horizontally wider toward the front edge 82 of the shingle 62, as illustrated by the cutout 48d. Preferably, each shingle 62 includes at least one of each of the cutouts 48a, 48b, 48c, and 48d described herein, although such is not required. Each shingle 62 can include any desired combination of cutout types.

If desired, the tabs 46 of the first overlay sheet 28 can include one or more slits 84. The shingle 62 illustrated in FIG. 4 is shown having slits 84 in one tab 46 of the first overlay sheet 28. However, it will be understood that any desired number of slits 84 can be formed in any desired number of tabs 46. The slits 84 can also be formed in the first overlay sheet 28, or in both the first and second overlay sheets, 28 and 30. Preferably, the slits 84 include edges that are tapered so that they are horizontally wider toward the front edge 80 of the tab 46. The slits 84 are provided to simulate irregularities that occur naturally in cedar shake roofing. The slits 84 differ from the cutouts 48 in that each slit 84 is vertically substantially smaller than each of the cutouts 48.

Preferably, as best shown in FIG. 9 each section 50a through 50e of the underlay sheet 52A is horizontally wider than an associated tab or tabs 46a through 46f of the overlay assembly 63, such that a portion 53 of the underlay sheet 52A is exposed on either side of the tabs 46a through 46f. For example, section 50a is horizontally wider than its associated tabs 46a and 46b. Preferably, the portion 53 of the underlay sheet 52A exposed on either side of each tab 46a through 46f has a width W under one inch, and more preferably within the range of from about 1/16 inch to about 3/16 inch.

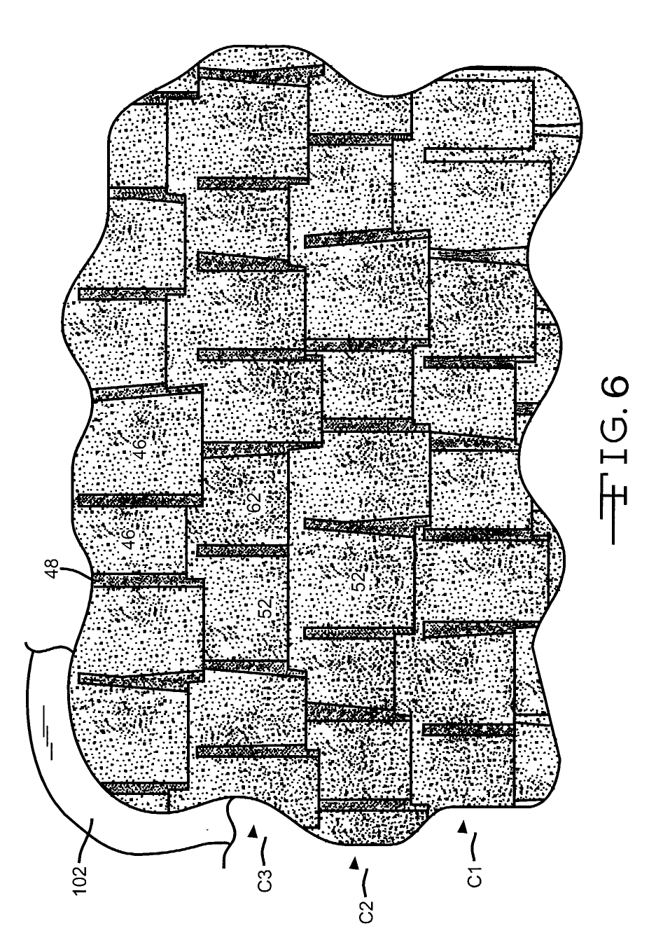

The exposed portions of the underlay sheet 52A, including the portions of the underlay sheet 52A that show through the overlay assembly cutouts 48 in the completed shingle 62, are preferably generally darker than the overlay assembly 54. The term “generally darker” is defined as a surface portion having an overall appearance that reflects less light and is darker than a contrasting area, even though some individual granules may have a lighter color. As shown in FIG. 6, the installation of the shingles 62 can be in courses, C1, C2, and C3. It will be understood however, that the exposed portions of the underlay sheet 52 can be lighter than the overlay assembly 54. Also, instead of being darker or lighter than the overlay assembly 54, the underlay sheet 52 could merely be a contrasting color or shade from that of the overlay assembly 54.

It will be appreciated that a shingle manufactured according to the method of the invention advantageously provides an increased appearance of thickness and depth, and replicates the randomness and deep shadows found in natural shake roofing, such as cedar shake roofing. A random combination of tabs 46 and slots 48, as shown in FIG. 6, provides the shingle 62 with a natural cedar appearance. Because each end of the shingle 62 is cut through a cutout 48, any two shingles 62 can be placed adjacent one another on a roof. Further, as shown in FIG. 6, seams defined between adjacent shingles 62 in one course C1 are hidden by the tabs 48 of the shingles 62 in an adjacent course C2.

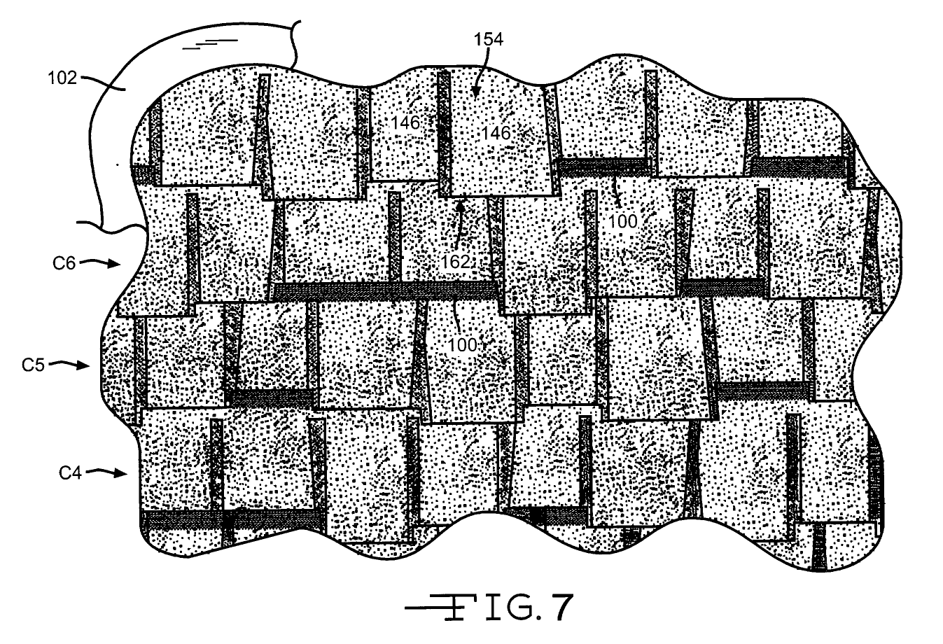

An alternate embodiment of the invention is illustrated in FIG. 7, and includes the shingle 162. As shown in FIG. 7, a plurality of the shingles 162 can be installed as a roof covering on a roof 102. The installation of the shingles can be in courses, C4, C5, and C6. The shingle 162 is substantially identical to the shingle 62, but is provided with a horizontal shadow line 100. The shadow line 100 is on the overlay assembly 52 and a portion of the shadow line is covered by the tabs 146 of a shingle 162 in the overlying or subsequent course of shingle, the tabs 146 further defining an exposed portion of the shadow line 100. Preferably, the shadow line 100 formed with various patches of granules relatively darker than the remainder of the overlay assembly 154 exposed by the adjacent shingle. Such shadow lines 100 can also be included at any desired location on the overlay tabs 146 to add richness and depth to the appearance of the shingle when assembled on a roof. In an alternative embodiment, the underlay extends across the width of the sheet ant the bottom edge of the underlay corresponds with the bottom edge of the longest tab, and therefore a portion of the bottom edge of the underlay is coextensive with the longest tab, and a second portion comprises a shadow line.

Another alternate embodiment of the invention is illustrated in FIG. 8, and includes the shingle 262. As shown in FIG. 8, a plurality of the shingles 262 can also be installed as a roof covering on a roof 102. The installation of the shingles can be in courses, C7, C8, and C9. The shingle 262 is substantially identical to the shingle 62, but is provided with a plurality of tabs 246 each having an equal vertical length H1. A horizontal shadow line 200 is provided and extends across at least some of the tabs 246 such that the shadow line 200 is visible when the shingle is installed on a roof. Preferably, the shadow line 200 is darker than the remainder of the exposed overlay assembly 254. In another embodiment, as shown in the lower right comer of FIG. 8, the shadow 200 extends to under one of the tabs 246 to provide better resistance to tearing of the underlay at the corner of this cutout in the underlay. Additionally, the edge of the shadow may be angled as shown in FIG. 4 at cutout 48b, but the angle provided to place the termination of the shadow below a tab, versus in a cutout.

The principle and mode of operation of this invention have been described in its preferred embodiments. However, it should be noted that this invention can be practiced otherwise than as specifically illustrated and described without departing from its scope.

What is claimed is:

1. A laminated shingle having a horizontal longitudinal orientation, the shingle comprising:
a first overlay sheet having a series of horizontally extending tabs and cutouts, each tab having a front edge; and
an underlay sheet laminated beneath the first overlay sheet, the underlay sheet including more than one section, each section having a vertical length relative to a back edge of the underlay sheet, the vertical lengths of at least some of the sections differing from each other, each section being associated with one or more tabs of the overlay sheet and having a front edge;
wherein the front edge of each section of the underlay sheet is substantially aligned vertically with the front edge of its associated one or more tabs of the overlay sheet.

2. The shingle according to claim 1, wherein the first overlay sheet has a first end and a second end, a first cutout defining the first end of the first overlay sheet, and a second cutout defining the second end of the first overlay sheet.

3. The shingle according to claim 1, wherein the sections of the underlay sheet are horizontally wider than their associated one or more tabs of the overlay sheet, such that a portion of the underlay sheet is exposed on either side of the tabs.

4. The shingle according to claim 1, further including a second overlay sheet having a shape substantially identical to the shape of the first overlay sheet, the second overlay sheet being laminated beneath the first overlay sheet to form an overlay assembly which is laminated above the underlay sheet.

5. The shingle according to claim 1, wherein the exposed portions of the underlay sheet are generally darker than the first overlay sheet.

6. The shingle according to claim 1, wherein a cutout of the first overlay sheet has cutout edges that are substantially parallel to each other.

7. The shingle according to claim 1, wherein a cutout of the first overlay sheet has cutout edges that are tapered such that the cutout is horizontally wider toward a front edge of the shingle.

8. The shingle according to claim 1, wherein a cutout of the first overlay sheet has cutout edges that are tapered such that the cutout is horizontally narrower toward a front edge of the shingle.

9. The shingle according to claim 1, wherein a cutout of the first overlay sheet includes a rear cutout portion having cutout edges that are substantially parallel to each other, and a tapered front cutout portion such that the front cutout portion is horizontally wider toward a front edge of the shingle.

10. The shingle according to claim 1, wherein the first overlay sheet includes at least one cutout that is tapered such that it is horizontally wider toward a front edge of the shingle, at least one cutout that is tapered such that it is horizontally narrower toward the front edge of the shingle, at least one cutout that has cutout edges that are substantially parallel to each other, and at least one cutout including a top cutout portion having cutout edges that are substantially parallel to each other and a tapered front cutout portion such that the front cutout portion is horizontally wider toward a front edge of the shingle.

11. The shingle according to claim 1, wherein the overlay sheet includes a horizontal shadow line, at least some of the tabs of an adjacent shingle covering a portion of the horizontal shadow line when the shingle is installed on a roof with a plurality of similar shingles as a roof covering, the tabs defining exposed portions of the horizontal shadow line, the shadow line being darker than the remainder of the overlay sheet exposed by the adjacent shingle.

12. The shingle according to claim 1, wherein no more than two adjacent tabs of the overlay sheet have substantially equal vertical lengths.

13. The shingle according to claim 1, wherein the overlay sheet includes a horizontal shadow line extending across at least a portion of the tabs such that the shadow line is exposed when the shingle is installed on a roof with a plurality of similar shingles as a roof covering, the shadow line being darker than the remainder of the overlay sheet of the shingle.

14. The shingle according to claim 4, wherein the first overlay sheet includes a back edge, and the second overlay sheet includes a back edge, the back edge of the second overlay sheet being spaced vertically apart from the back edge of the first overlay sheet.

15. The shingle according to claim 1, further comprising one or more slits provided at the front edge of one or more of the overlay tabs.

16. The shingle according to claim 15, wherein the slits comprise a pair of edges, said slit edges being tapered so that they are horizontally wider toward the front edge of the tab, and having a substantially shorter length than the slit edges of the tabs.

17. The shingle according to claim 16, further including a second overlay sheet having a shape substantially identical to the shape of the first overlay sheet, the second overlay sheet being laminated beneath the first overlay sheet to form an overlay assembly which is laminated above the underlay sheet.

18. A method of making shingles comprising the steps of:
a. coating a continuously supplied shingle mat with roofing asphalt to make an asphalt coated sheet;
b. covering the asphalt coated sheet with granules to form a continuous granule covered sheet, the continuous granule covered sheet comprising a first overlay sheet, a second overlay sheet, and an underlay sheet;
c. longitudinally cutting the second overlay sheet from the continuous granule covered sheet, and defining a remainder of the continuous granule covered sheet;
d. laminating the second overlay sheet to an underside of the first overlay sheet of the of the remainder of the continuous granule covered sheet, the first overlay sheet and the second overlay sheet defining an overlay assembly portion;
e. simultaneously cutting a pattern of tabs and cutouts in the overlay assembly portion, and cutting a pattern of one or more sections in the underlay sheet of the continuous granule covered sheet, each tab of the overlay assembly portion having a front edge, each section having a vertical length relative to a back edge of the underlay sheet, the vertical lengths of at least some of the sections differing from each other, each section being associated with one or more tabs of the overlay assembly portion and having a front edge, the underlay sheet being separated from the overlay assembly portion and defining a continuous underlay sheet, the overlay assembly portion defining a continuous overlay assembly;
f. synchronizing the pattern of one or more underlay sections of the continuous underlay sheet relative to the pattern of tabs and cutouts of the continuous overlay assembly, such that the front edge of each section of the underlay sheet is substantially aligned vertically with the front edge of its associated one or more tabs of the overlay assembly portion;
g. laminating the continuous underlay sheet to an underside of the continuous overlay assembly to form a continuous laminated shingle sheet;
h. synchronizing the pattern of tabs and cutouts of the continuous laminated shingle sheet relative to a shingle length cutter; and
i. cutting the continuous laminated shingle sheet with the shingle length cutter such that each cut is in made through a cutout of the continuous laminated shingle sheet.

19. The method according to claim 18, wherein the first overlay sheet includes a back edge, and the second overlay sheet includes a back edge, and wherein step (d) further includes laminating the second overlay sheet to an underside of the first overlay sheet of the remainder of the continuous granule covered sheet, such that the back edge of the second overlay sheet is spaced vertically apart from the back edge of the first overlay sheet.

20. The method according to claim 18, further comprising the step of forming one or more slits at the front edge of one or more of the overlay tabs.
